(19) United States
(12) Patent Application Publication
(10) Pub. No.: US 2005/0248543 A1
(43) Pub. Date: Nov. 10, 2005

(54) Theft resistant monitor

(76) Inventors: Kenneth J. North, San Carlos, CA (US); Peter C. Studt, San Ramon, CA (US); Joseph Barbarasch, Redwood City, CA (US)

Correspondence Address: TYCO ELECTRONICS CORPORATION, MAIL STOP R20/2B, 307 CONSTITUTION DRIVE, MENLO PARK, CA, 94025, US

(21) Appl. No.: 11/117,795

(22) Filed: Apr. 28, 2005

Related U.S. Application Data
(60) Provisional application No. 60/567,348, filed on Apr. 30, 2004.

(51) Int. Cl. G09G 5/00

(52) U.S. Cl. 345/173

(57) ABSTRACT

A theft resistant touch sensor system is provided that can be easily integrated into a touch monitor and configured to be used with a wide variety of host computers. The theft resistant touch sensor system involves a handshake procedure conducted between a controller and a host computer. The controller acts to disable a display for the touch sensor system if the handshake is not successful. The system can be updated remotely via network connections, but does not require continuous intervention by a network connection. The system includes a touch sensor capable of detecting a presence and location of a touch on a touch sensitive surface and a display located proximate the touch sensor, the display providing information correlated to a touch location. The touch sensor system also provides a controller capable of transmitting and receiving information from the sensor that includes a first data input/output port. The controller can communicate with a computer through the first data port. The controller has a local memory storing a password on the touch monitor. The controller is configured to compare the first password from the local memory to a second password provided by the computing means. If the passwords match, the controller is configured to provide an output that enables the display. If the passwords do not match, the controller is configured to provide an output that disables the display.

### CROSS-REFERENCE TO RELATED APPLICATIONS

This application is an application under 35 USC 111(a) and claims priority under 35 USC 119 from Provisional Application Ser. No. 60/567,348, filed Apr. 30, 2004 under 35 USC 111(b). The disclosure of that provisional application is incorporated herein by reference.

### BACKGROUND OF THE INVENTION

1. Field of the Invention

This invention relates to touchscreen monitors and touchscreen systems, in particular touchscreen systems having theft-prevention means associated with the monitors.

2. Introduction to the Invention

A touchscreen system includes a touchscreen display or monitor having a touch sensor for sensing the presence and location of a touch on a touch sensitive surface of the touch sensor. The touchscreen system also includes a controller for transmitting information between a computer and the touchscreen monitor.

The use of touchscreen kiosks has become prevalent around the world in a wide variety of applications, including self-service or information systems for retail, transportation, food and entertainment industries. In many of these applications, the touchscreen systems including touchscreen monitors are left for access in public arenas. Any type of monitor can be a target for theft, especially a valuable or desirable monitor, e.g., a CRT (cathode ray tube) terminal, flat panel displays such as LCD or plasma displays, or displays using new technology such as OLED (organic light emitting diodes).

Various theft prevention schemes have been implemented to prevent theft of computers, computer systems, and peripherals attached to computer systems. Many of these schemes involve locking mechanisms or identification (serial) numbers. However, in some conditions (e.g., when the computer system is located in a public or unsupervised area), locking mechanisms can be easily defeated and peripherals such as monitors can be stolen and identification numbers obliterated or altered. Other theft prevention schemes involve user-supplied passwords. However, such schemes are not useful for computer systems being used in public situations. Other theft prevention schemes involve imbedding hidden tags having identification codes into peripherals that can set off alarms in the event of theft (see for example U.S. Pat. No. 5,821,859). However, these methods may not be sufficient in remote or unsupervised areas or when the alarm is easily defeated. Chips having identification codes can be imbedded in computers for theft prevention, where the chips can be remotely addressed using radio signals (e.g., U.S. Pat. No. 6,654,890), however the equipment to provide radio signals may be expensive or subject to local regulations. U.S. Pat. Nos. 6,249,868 and 6,594,765 disclose methods for using a server coupled to agents embedded within various devices within a personal computer to prevent theft of the computer or peripherals attached thereto. The agents are either hardware-implemented logic circuits included in the devices or firmware or software routines running within the devices that can be directed to enable and disable the devices in which they are embedded.

Therefore, there exists a need for improved and simple theft prevention systems for peripherals attached to computers, particularly monitors and touchscreen monitors, that are left unattended in remote or public arenas. In addition, there exists a need for theft prevention systems for touchscreen monitors that can be easily implemented over a network to avoid a requirement to dispatch personnel to a number of sites. The theft prevention system should be adaptable to a wide range of both software versions (e.g., operating systems) and hardware versions to accommodate various public or remote systems that may have been put in place over a wide range of timescales and may have been irregularly updated.

### BRIEF SUMMARY OF THE INVENTION

A theft resistant touch sensor system is provided that can be easily integrated into a touch monitor and configured for use with a wide variety of host computers. The theft resistant touch sensor system involves a handshake procedure conducted between a controller in a touch monitor and the host computer. The controller acts to disable a display for the touch sensor system if the handshake is not successful. The system can be updated remotely via network connections, but does not require continuous intervention by a network connection.

In a first aspect, this invention provides a theft resistant touch sensor system comprising a touch sensor capable of detecting a presence and location of a touch on a touch sensitive surface and a display located proximate the touch sensor, the display providing information correlated to a touch location. The touch sensor system also provides a controller means capable of transmitting and receiving information to and from the sensor, the controller means including a first data input/output port. The controller means can communicate with a computing means through the first data port. The controller means includes a stored first password. The controller means is configured to compare the first password to a second password provided by the computing means. If the passwords match, the controller means is configured to enable the display. If the passwords fail to match, the controller means is configured to disable the display.

In a second aspect, this invention provides a method for making a theft-resistant touch sensor system that comprises providing a touch sensor capable of detecting a presence and location of a touch on a touch sensitive surface and a display located proximate the touch sensor, the display providing information correlated to a touch location. The method includes providing a controller means having a first input/output data port, the controller being capable of transmitting and receiving information to and from the sensor and communicating with a computing means through the first data port. The method includes storing a first password in the controller means. The method includes comparing the first password to a second password provided by the computing means. The method includes configuring the controller means to provide an output to enable the display if the passwords match, or provide an output to disable the display if the passwords fail to match. In a preferred embodiment, the controller means can be configured to compare the first password to the second password.

In a third aspect, this invention provides a handshaking process conducted between a touch monitor and a computing means, the process including providing a controller means located in the touch monitor, storing a first password in the controller means, comparing the first password with a second password provided by the computing means, and disabling a display portion of the touch monitor if the first password is different from the second password. In preferred embodiments, the controller means is configured to compare the first password with the second password, and to provide a signal to disable the display if the passwords do not match.

### BRIEF DESCRIPTION OF THE DRAWINGS

These and other objects, advantages, aspects and features of the present invention will be more fully understood and appreciated upon consideration of the detailed description of preferred embodiments presented in conjunction with the following drawings in which:

FIG. 1 illustrates a conventional touchscreen system combined with a computer;

FIG. 2 shows a block diagram of a theft resistant touch sensor system of the present invention connected to a host computer;

FIG. 3 shows a flowchart illustrating an example of a handshake process of the present invention;

FIG. 4 shows a flowchart illustrating a process for updating a seed value of the present invention;

FIG. 5 is a schematic layout of an interface system of the present invention, the interface system being connected to a touch controller and a computer;

FIG. 6 is a schematic diagram of an input board of the present invention; and

FIG. 7 is a schematic diagram of a locking circuit of the present invention.

### DETAILED DESCRIPTION OF THE INVENTION

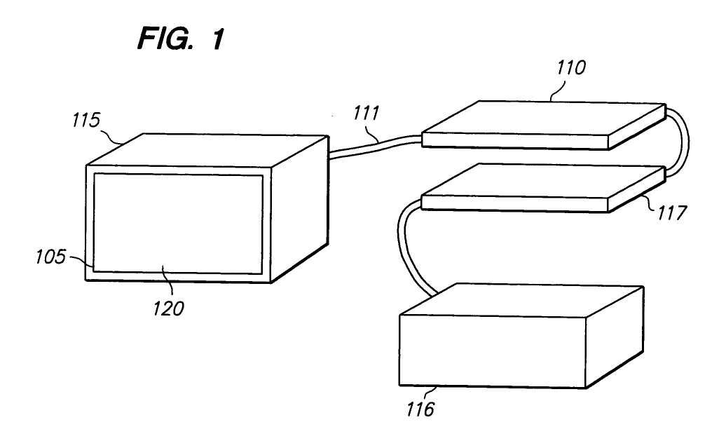

A conventional touch sensor system where the touch sensor is a touchscreen is shown in FIG. 1. A touchscreen system generally includes a touchscreen 105 (i.e., a touch sensor having a transparent substrate), a touch controller 110, and a connector (e.g., a lead) 111 coupling the touch controller 110 to the touchscreen 105. The touchscreen system can respond to a touch on the touchscreen 105. Any suitable touch-sensitive technology can be used for the touchscreen, e.g., acoustic, resistive, infrared, or capacitive. The touch controller 110 uses perturbations in the relevant signal (e.g., for an acoustic touchscreen, the controller senses perturbations in acoustic signals) to identify the presence and location of a touch on the touch sensitive surface 120 of touchscreen 105. If the controller 110 identifies a touch as valid, it can transmit the touch's position to a host computer 116 that then implements a corresponding computer function to display the corresponding information, e.g., graphics, on the display device 115. The touchscreen system combined with a display monitor 115 is referred to as a touch monitor. The touch controller 110 can be directly connected to a host computer 116. Optionally, touch monitors can be provided with an interface system 117 configured so that the touch monitor is connected to a host computer through the interface system 117. Although the touch controller 110 is shown as physically removed from the touch monitor in FIG. 1, it is typically integrated into the display portion of the touch monitor. Interface system 117 can also be integrated into the touch monitor.

The display device 115 can take the form of any device that displays information to an observer. For example, the display device 115 can be a cathode ray tube terminal (CRT) or a flat panel display such as a liquid crystal (LCD) display, plasma display or electroluminescent display. LCD monitors have recently become more widespread in their use due to their much reduced footprint requirements and their reduced weight.

The touch controller 110 operates a transmit/receive assembly in the touch sensor 105 in a predetermined sequence so that when a touch is detected via a perturbation in signal (e.g., acoustic wave energy for an acoustic sensor), the detected signal has been converted to an electrical signal and fed back to the controller, the location of the touch can be identified by the touch controller 110 and converted to control signals containing information about the presence and location of the touch. In performing its function, the touch controller uses coded instructions (that can be stored in a processor, for example), which when executed, control and process the relevant signals. The controller 110 can be implemented in hardware or firmware, and typically includes a microprocessor.

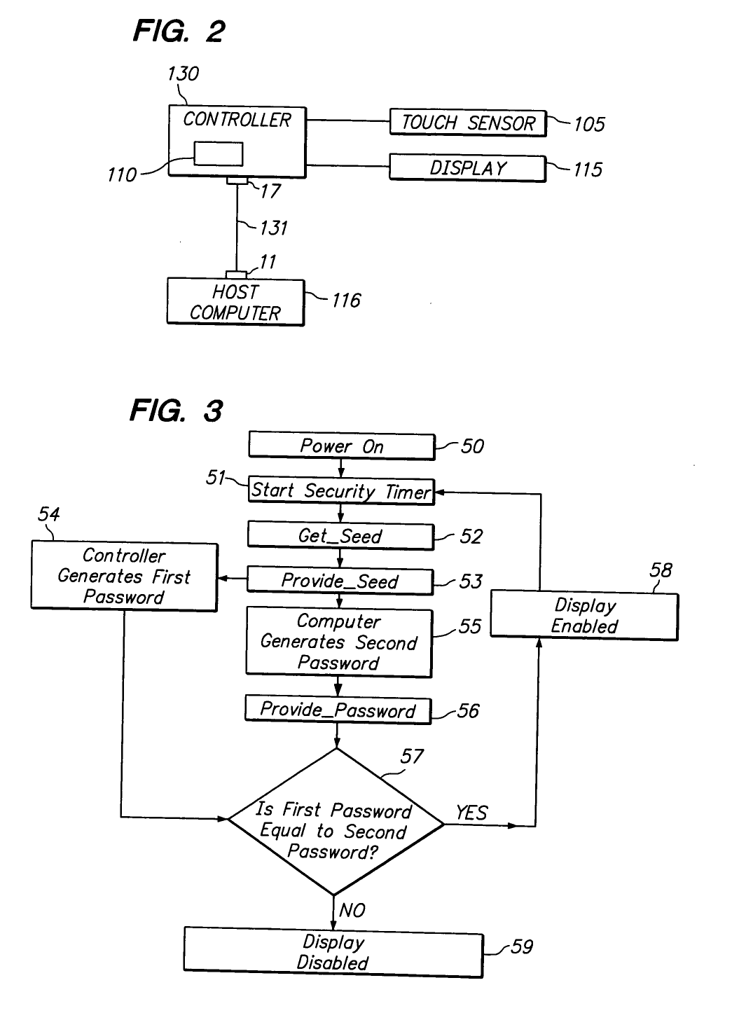

A first embodiment of a theft resistant touch sensor system is shown in FIG. 2. A touch monitor comprising controller means 130, touch sensor 105 and display 115 is connected to host computer 116. The controller means 130 comprises touch controller 110. Controller means 130 can comprise a microcontroller (not shown). Controller means 130 is capable of receiving and transmitting touch information (i.e., the presence and location of touches on touch sensor 105). In addition, controller means 130 communicates with host computer 116 through input/output data ports 17 and 11 and interconnect 131.

When the touch sensor system and host computer are powered up, controller means 130 and host computer 116 conduct a sequence of instructions during a security timer set for a predetermined length of time (e.g., 10 minutes). These instructions include a command sent to the host computer 116 by controller means 130 to provide a password (Provide_Password command). The controller means compares the password provided by the computer to a password stored locally in the controller means. The computer's password is accepted as valid if it matches the controller mean's password, and the handshake process between the host computer 116 and controller means 130 is successfully completed. The security timer is refreshed whenever the host computer 116 sends a valid password to controller means 130 in response to a Provide_Password command. If the sequence of instructions is not completed within the preset time period, the security timer will expire and the controller means will send an output signal that disables the display. If the security timer is allowed to expire, the display can be re-enabled by receipt of a valid password from computer 116 in response to the Provide_Password command, and the security timer will begin to run again. If controller means 130 includes a microcontroller, the microcontroller can be configured to conduct the security handshake process. The controller means needs to send data to the computer 116, it can disable the data receiver from the touch controller 110 and provide its data to a line driver feeding the data port 11. If a microcontroller is used as part of controller means 130, the microcontroller can periodically disable the data receiver from the touch controller 110 and provide data to the computer 116 via a line driver feeding the data port 11.

The sequence of instructions carried out during the security timer period can include an algorithm, e.g., a hashing algorithm. A hashing algorithm is one in which a look-up table is provided where a first value can be converted to a second value, and the conversion is provided by the look-up table. For example, a simple look-up table could convert the numbers 1, 2, 3 to the letters A, B, C, respectively. The algorithm is applied to a seed value, preferably a randomly generated seed value, to produce a password. The seed value and the algorithm can be stored locally in controller means 130, for example in an EEPROM (not shown), as part of a touch monitor. In addition, the algorithm can be stored in the computer 116. To determine the password, the host computer 116 can request the seed value from the monitor (through controller means 130) and apply the algorithm to generate the password. In addition, to provide extra security, the computer can change the seed value received from the touch controller into a modified seed value, and use the modified seed value to generate the password. Any number or combination of look-up tables or formulas can make up the algorithm. Each byte of the seed value can be independently operated upon by the look-up tables or formulas to produce the password. The password can be of the same length or of a different length than the seed value.

The operation of an embodiment of the theft resistant touch monitor is shown as a flowchart in FIG. 3. First, the host computer and the touch monitor are powered on (50). Controller means 130 in the monitor starts a security timer (51). The host computer sends a series of commands to the controller 130 on the monitor (Get_Seed commands) (52). The Get_Seed commands can be sent as often as desired, but the rate of sending them should not exceed the rate at which the host computer exchanged touch information with the touch controller (e.g., once every 25 milliseconds). When the controller means 130 in the monitor successfully receives a Get_Seed command from the host computer, it reads the seed value from its local memory (e.g., EEPROM) and sends the seed value back to the computer 116 (Provide_Seed response) (53). In addition, the controller means provides the seed value to its locally stored algorithm to calculate a first password (54). When the computer receives the seed value, it inputs it into the algorithm to generate a second password (55). The computer sends the second password back to the controller means (Provide_Password command) (56). The controller means 130 then compares the first and second passwords (57). If the passwords match, then the controller 130 provides a signal output that enables operation of the display 115 (58) and resets the security timer, and steps 51-58 can be repeated at prescribed intervals (e.g., once every 10 minutes). If the passwords do not match, the controller 130 sends a signal output that disables operation of the display 115 (59) and the touch monitor will stop functioning, thereby deterring theft of the touch monitors. The display may be disabled in a variety of ways, for example, by interrupting power to the display or by interrupting a signal to the display, e.g., the video signal or synchronization signal. In some cases, it may be useful to modify the above procedure so that the monitor is not disabled until more than one improper handshake (i.e., the first and second passwords do not match) takes place. This feature can be useful for testing touch monitors in a manufacturing environment so they can be tested or put through a burn-in process without having to be connected to a host computer. In addition, the time interval between required handshakes can be adjusted to fit specific use circumstances (e.g., data rate and level of use).

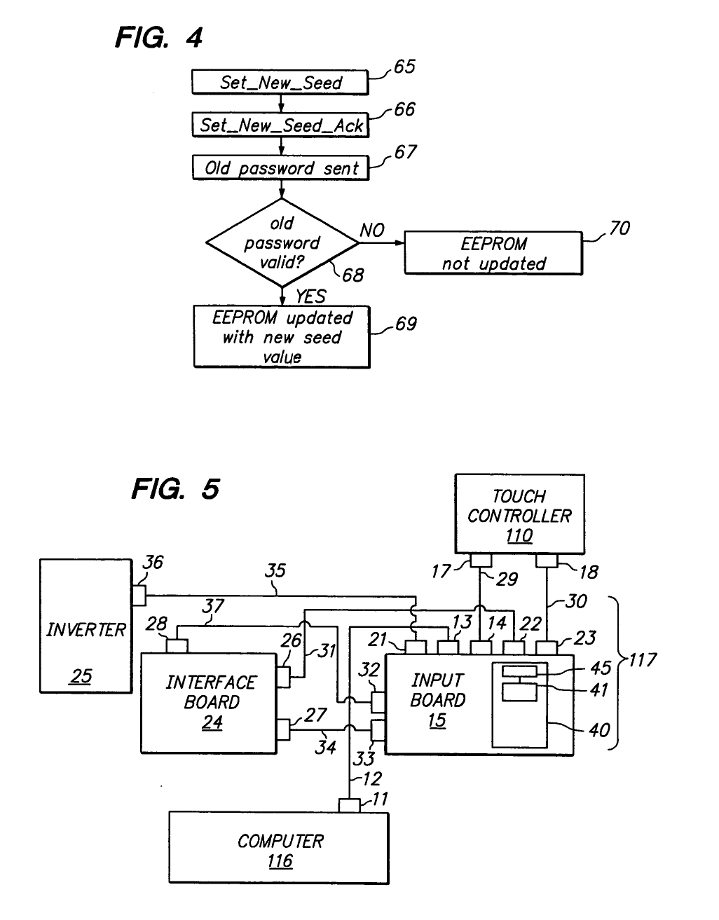

FIG. 4 illustrates another embodiment of the present invention in which the computer can change the seed value stored in the local memory of the monitor. This can allow an extra layer of security in completing a proper handshake between a touch monitor and a host computer. In this embodiment, the following steps are included. The host computer 116 sends a new seed value to the controller means 130 in the monitor (Set_New_Seed command) (65). The controller 130 on the monitor responds to the host computer 116 with a Set_New_Seed_Ack acknowledgment (66). The controller means sends the old password generated from the old seed value to the computer (67). If the old password is received by the computer and accepted as valid (68), the controller means 130 updates its memory (e.g., EEPROM) with the new seed value (69). The host computer must now supply the new password within the intervals defined by the security timer to ensure the display is not disabled. If the old password is not accepted as valid, the memory is not updated with the new password (70), and therefore the new password will not be established.

The controller means 130 (which may include a microcontroller) can be configured to ignore all data traffic except for the following three commands: 1) Get_Seed; 2) Provide Password; and 3) Set_New_Seed. As described above and shown in FIG. 3, the Get_Seed command is issued by the host computer to get the seed value from the controller means 130 so that it can generate the password. Upon receipt of the Get_Seed command, the controller means reads the seed value from its local memory and generates a Provide_Seed response back to the host computer and includes the seed value in the response (e.g., in the data bytes section of the report). In addition, the controller means 130 locally caches the seed value and generates the password itself so that it will be ready to compare its self-generated password with the computer-provided password.

The Provide_Password command contains the password in the command message, e.g., in the data bytes section. Upon receipt of the Provide_Password command, the controller means 130 will compare the password in the message with its own generated password. If the passwords match, the controller means 130 sends an output signal to enable the display, and if the passwords do not match, the display will be disabled. In one embodiment, the controller means must receive the Provide_Password command at least once during the prescribed security timer interval for the monitor to continue to function. In other embodiments, the controller means must receive the Provide_Password command at least once during a multiple number of security timer intervals (e.g., two times) for the monitor to continue to function.

A schematic diagram of an embodiment of the present invention including an interface system 117 combined with a touch controller 110 and host computer 116 is shown in FIG. 5. The computer 116 is connected to the touch controller 110 through input board 15 of interface system 117. Input board 15 can provide power to the system (e.g., 12 VDC and 5 VDC) and also can monitor data between touch controller 110 and computer 116. Input board 15 can transmit and receive information to/from touch controller 110 via input/output data ports 14, 17 and interconnect 29, and can transmit and receive information to/from host computer 116 via input/output data ports 11, 13 and interconnect 12. In addition, input board 15 can supply power to touch controller 110 via connections 18, 23 and interconnect 30. Input board 15 can include a locking circuit 40 that is part of a power supply section of input board 15. Locking circuit 40 can include microcontroller 41 and EEPROM 45. In addition to the input board 15, the interface system 117 can include interface board 24, inverter board 25, and interconnections 31, 34, 35, 37. Inverter board 25 can provide illumination for the touch sensor system and is connected to the display (connection not shown). Inverter board 25 is connected at 36 to input board 15 at 21 through interconnect 35. Interface board 24 provides video input to display 115 (connection not shown). Interface board 24 is connected to input board 15 between connection points 27 and 33 via interconnect 34, between connection points 26 and 22 via interconnect 31, and between connection points 28 and 32 via interconnect 37. The interconnections can comprise any suitable cables and connectors.

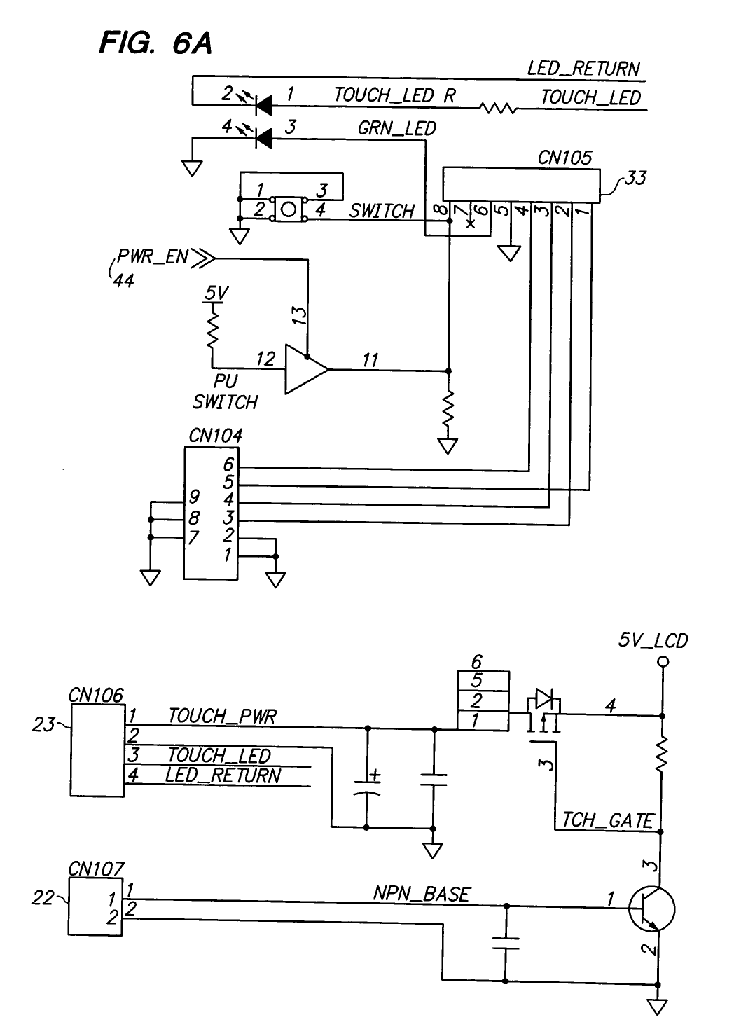

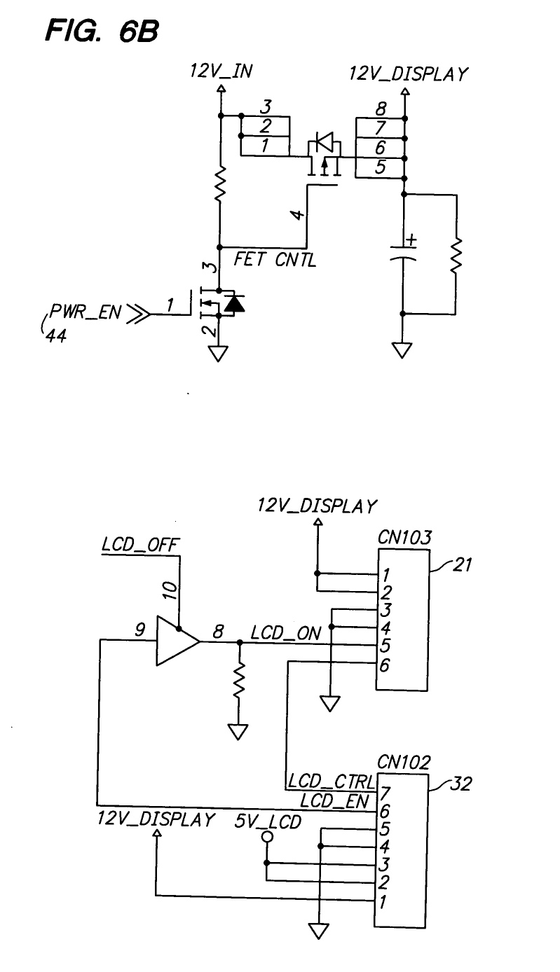

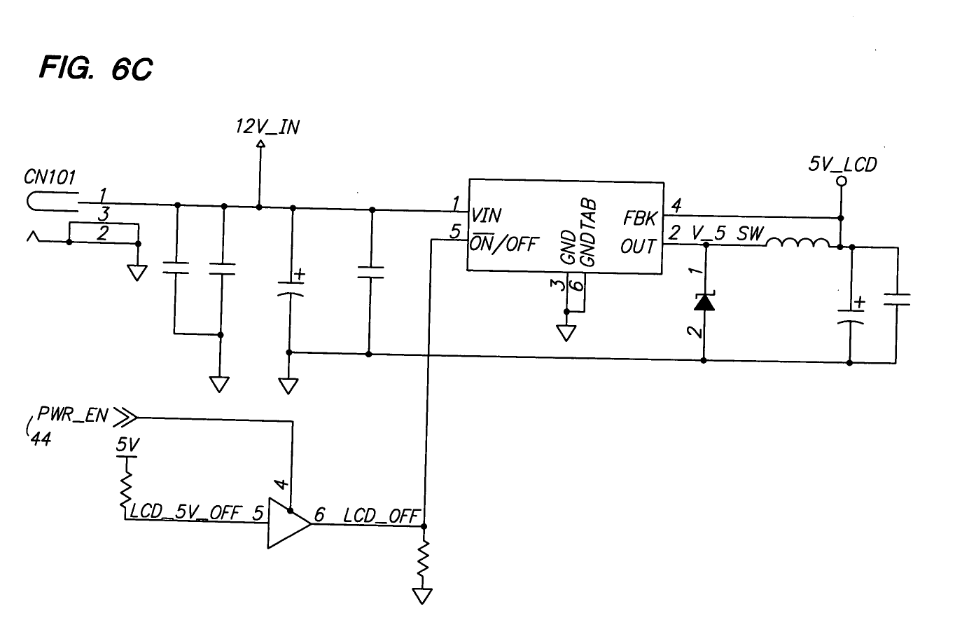

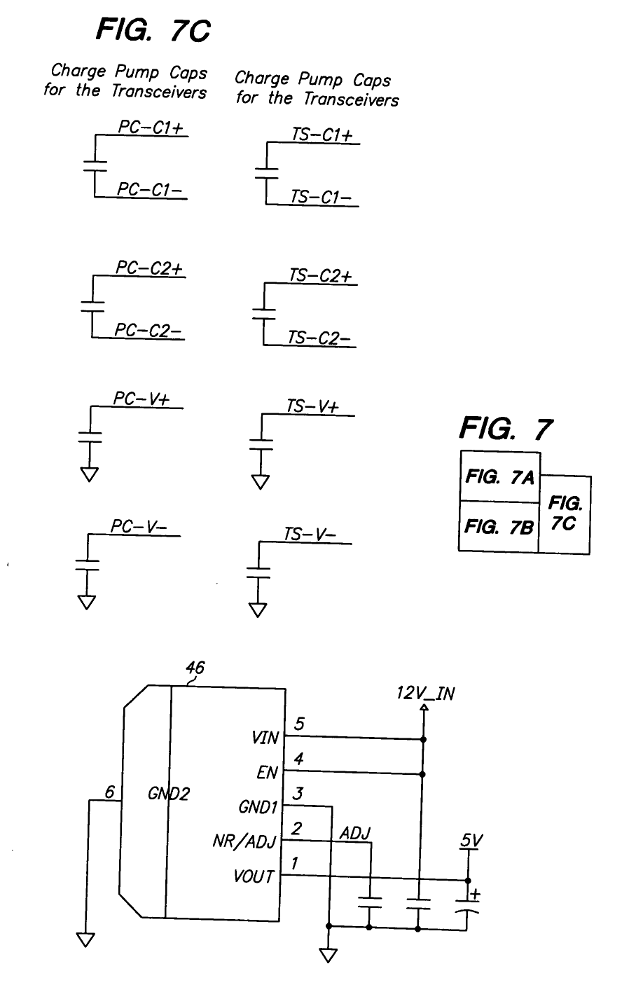

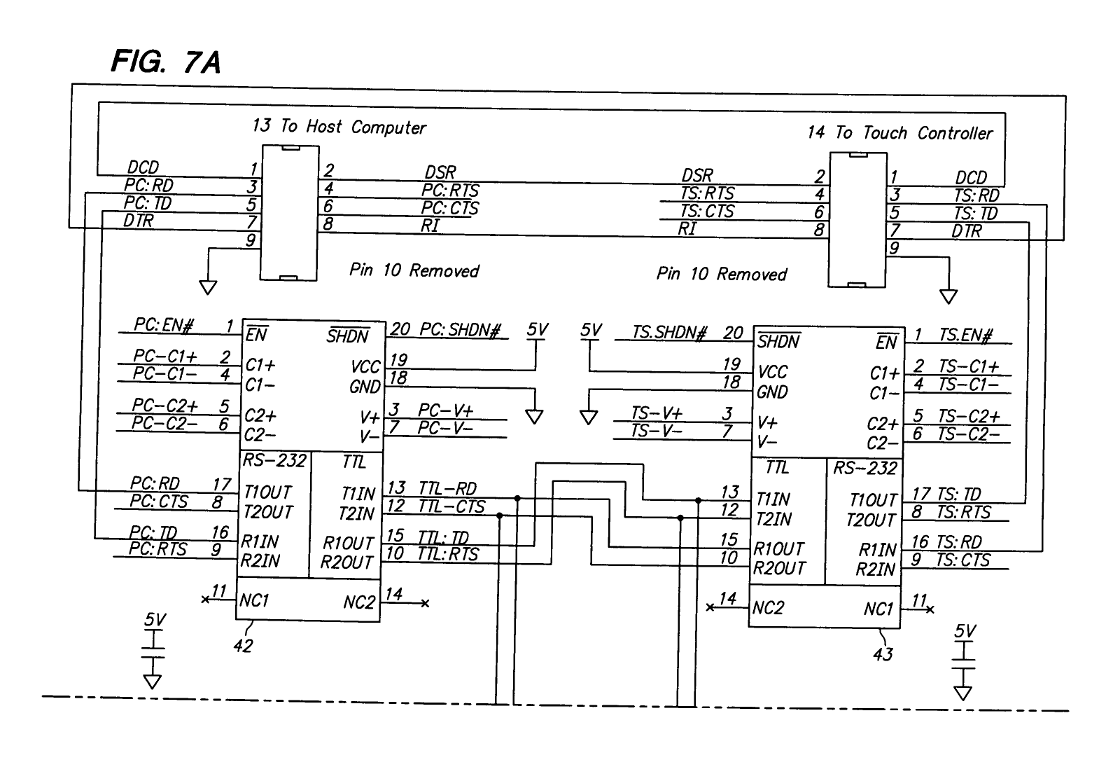

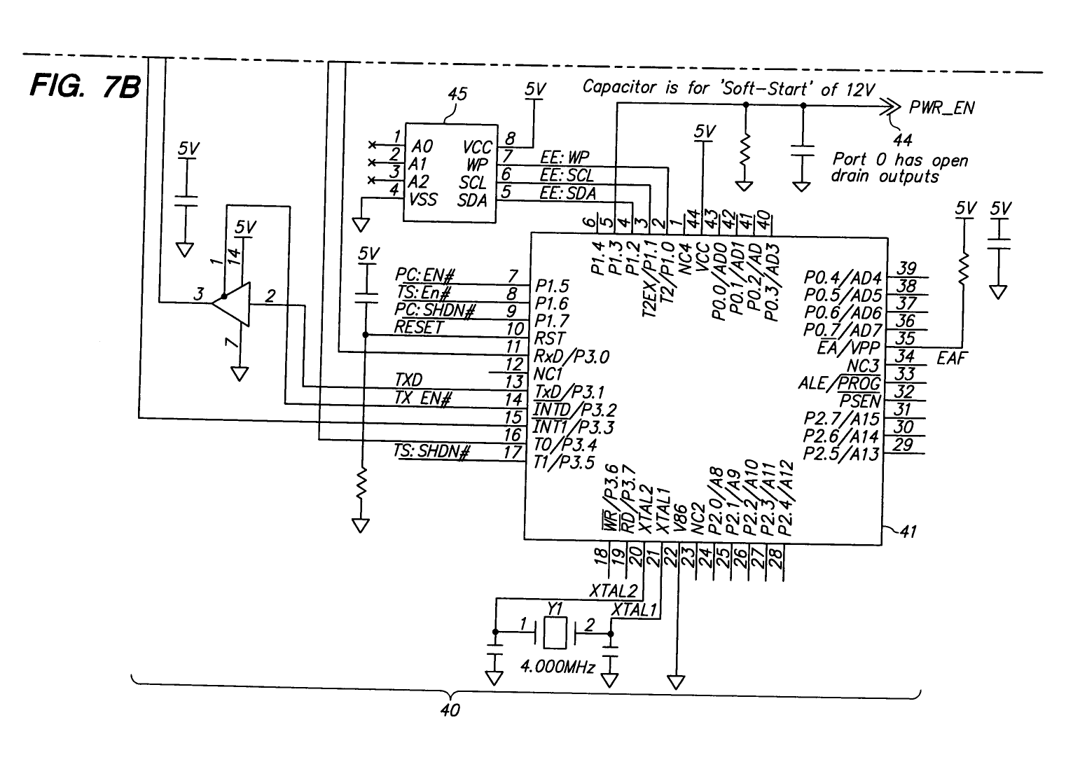

The layout of the example of the input board 15 is shown in more detail in FIGS. 6 and 7. FIG. 7 shows a layout of locking circuit 40 as part of the power supply section of input board 15. The power supply section can include other circuits in addition to locking circuit 40, including voltage regulator 46. Locking circuit 40 can include microcontroller 41 and is connected at data port 13 to the host computer 116 and at data port 14 to the touch controller 110. The locking circuit 40 can include a first transceiver 42 associated with data port 13 and a second transceiver 43 associated with data port 14. Data port 13 is connected to the host computer 116 at data port 11, and data port 14 is connected to the touch controller 110 at data port 17. Data can be transmitted between touch controller 110 and host computer 116 through the following path: through data port 17 to data port 14 to transceiver 43 to microcontroller 41 to transceiver 42 to data port 13 to data port 11. The data transmitted through this path can include touch information (e.g., the presence and location of touches) and locking information (e.g., whether a proper handshake or password exchange has taken place between the host computer 116 and microcontroller 41). As shown in FIG. 7, one signal output of locking circuit 40 is PWR_EN (44). As shown in FIG. 6, PWR_EN (44) is an input to several sections of input board 15. When the locking information (that is part of the data stream between the touch controller 110 and computer 116) indicates a proper handshake has taken place, the output signal PWR_EN 44 from the locking circuit enables the display and touch monitor to function. When a proper handshake or password exchange has not taken place, the PWR_EN output signal 44 is set to disable the display, for example, by operating to shut down any power input (e.g., disabling +5 VDC to the interface board 24, or disabling +12 VDC to inverter board 25), shut down video input (e.g., send a signal to inverter board 25 to disable it), or disrupt video input (e.g., by disabling synchronization signal to a CRT). The disabling of any of these functions causes the display 115 and hence the touch monitor to cease to function. However, the theft prevention touch monitors and methods described herein do not result in permanent disabling of displays.

As described above, the data path (e.g., serial data) between the host computer 116 and the touch controller board 110 can be routed to pass through the input board 15 (contained in the touch monitor unit). The data ports 11, 13, 14 and 17 can be any suitable data port type, e.g., serial (RS232), or USB. The data signals from the computer 116 can be modified by transceiver 42 so that they are acceptable to circuitry on the input board. For example, if the data is serial data, it can be translated to TTL voltage levels using an RS232 transceiver, e.g., a Maxim MAX3222ECWN Line Driver/Receiver. The TTL level signal can be routed to the microcontroller 41 on the input board to be monitored for the security handshake and also to transceiver 43 so that it can be provided to the touch controller 110. Data arriving from the touch controller 110 can be modified in a similar way, e.g., translated to TTL voltage levels by transceiver 43 and then routed to microcontroller 41 and transceiver 42 so that it can be provided to the host computer via data port 11. If the microcontroller itself wants to send data to the computer 116, it can disable the data receiver from the touch controller 110 and provide its data to the line driver feeding the data port 11.

The microcontroller 41 on the input board 15 can be any suitable microcontroller. For example an 8051 microcontroller from Intel, or a derivative of an 8051 such as the Philips P87C51SBBB. The microcontroller can monitor the data traffic between the host computer 116 and the touch controller 110. When a data packet designated for the locking circuit 40 of the power supply section of the input board 15 is received by the microcontroller 41, the microcontroller can take appropriate actions. To communicate with the host computer, the microcontroller can briefly interrupt the communication path from the touch controller to the host computer. The microcontroller 41 can have the following input/output ports: data channel to the host computer (e.g., serial data), EEPROM read/write/write protect, data receiver shutdown and disable outputs, and a power enable PWR_EN (e.g., 15 VDC) output. The microcontroller preferably automatically initializes on power up, enables the monitor, and starts a security timer interval. After start up, the microcontroller can monitor data traffic from the host computer for any commands directed to it. If the security timeout occurs prior to reception of a valid Provide_Password command, the display portion of the touch monitor can be disabled as described above.

The EEPROM microchip 45 in the locking circuit 40 of the power supply section of the input board 25 can be used to store the seed value for the algorithm including look-up tables or formulas necessary for converting the seed value into a password. An example of an EEPROM that can be used is a Microchip 24LC16B-I. The length of the seed value can be any suitable length, e.g., 6 bytes. Any number or combination of look-up tables or formulas can make up the algorithm. Each byte of the seed value can be independently operated upon by the look-up tables or formulas to produce the password. The password can be of the same length or of a different length than the seed value.

Touch sensor systems of the present invention can be used with any host computer. Appropriate drivers for the touch sensor system can be downloaded to a host computer via any suitable method, e.g., using remote installation over a network or by local installation. Updates to the touch sensor systems of the present invention (e.g., changing of seed values) can also be easily accomplished using network installation techniques, allowing units installed in the field to be continually be refreshed, further deterring theft.

The foregoing detailed description of the invention includes passages that are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly although the various figures and descriptions herein relate to specific features where a specific feature is disclosed in the context of a particular figure or embodiment, such feature can also be used, to the extent appropriate, in the context of another figure or embodiment, in combination with another feature, or in the invention in general.

It will be understood that the above-described arrangements of apparatus are merely illustrative of applications of the principles of this invention and many other embodiments and modifications may be made without departing from the spirit and scope of the invention as defined in the claims.

1. A theft resistant touch sensor system comprising:
(a) a touch sensor capable of detecting a presence and location of a touch on a touch sensitive surface;
(b) a display located proximate the touch sensor, the display providing information correlated to touch location; and
(c) controller means for transmitting and receiving information to and from the sensor, said controller means:
(i) comprising a first input/output data port, and a first password,
(ii) communicating with a computing means through the first data port, and
(iii) being configured to compare the first password to a second password provided by the computing means; and provide a first output to enable the display if the passwords match or a second output to disable the display if the passwords fail to match.

2. The touch sensor system of claim 1, wherein the first password comprises a first value and an algorithm stored in a memory of the controller means, the algorithm generating the first password from the first value.

3. The touch sensor system of claim 2, wherein the algorithm is stored in the computing means, the first value is provided by the controller means to the computing means, and the algorithm is used to generate the second password.

4. The touch sensor system of claim 1, wherein the second output comprises interrupting power to the display, or interrupting synchronization for the display.

5. The touch sensor system of claim 1, wherein the display comprises a cathode ray tube or a flat panel display.

6. The touch sensor system of claim 1, wherein information about the passwords is interspersed with touch data being communicated between the controller means and the computing means.

7. The touch sensor system of claim 1, wherein the controller means comprises a single controller.

8. The touch sensor system of claim 1, wherein the controller means comprises a touch controller and a microcontroller.

9. The touch sensor system of claim 8, wherein:
(a) the touch controller transmits and receives information to and from the touch sensor; and
(b) the microcontroller
(i) comprises a local memory storing the first password, and
(ii) is configured to compare the first password to the second password; and provide the first output if the passwords match or the second output if the passwords fail to match.

10. The touch sensor system of claim 8, wherein the microcontroller is located on an input board.

11. The touch sensor system of claim 10, wherein the input board comprises:
(a) second and third data input/output ports; and
(b) a locking circuit comprising the microcontroller,
the second data port being connected to the first data port and the third data port being connected to a fourth data input/output port on the computing means such that the touch controller can communicate with the computing means through the locking circuit.

12. The touch sensor system of claim 1, wherein the controller means is configured to compare the first password to the second password over a specified time limit.

13. The touch sensor system of claim 12, wherein the controller means is configured to compare the first password to the second password repetitively during operation of the system, the repetitive comparisons being spaced apart by the time limit.

14. The touch sensor system of claim 1, wherein the touch sensor comprises an acoustic touch sensor, a capacitive touch sensor, an infrared touch sensor, or a resistive touch sensor.

15. The touch sensor system of claim 1, wherein the controller means is integrated with the display.

16. A method for making a theft resistant touch sensor system comprising:
(a) providing a touch sensor capable of detecting a presence and location of a touch on a touch sensitive surface;
(b) providing a display located proximate the touch sensor, the display providing information correlated to a touch location;
(c) providing a controller means having a first input/output data port, the controller means being capable of transmitting and receiving information from the sensor and being capable of communicating with a computing means through the first data port;
(d) storing a first password in the controller means;
(e) comparing the first password to a second password provided by the computing means; and
(f) configuring the controller means to provide a first output to enable the display if the passwords match, or to provide a second output to disable the display if the passwords fail to match.

17. The method of claim 16, wherein the controller means repetitively compares the first and seconds passwords at a preset time interval.

18. The method of claim 16, wherein the controller means is configured to compare the first and second passwords.

19. A handshaking process conducted between a touch monitor and a computing means comprising:
(a) providing a controller means located in the touch monitor;
(b) storing a first password in the controller means;
(c) comparing the first password with a second password provided by the computing means; and
(d) disabling a display portion of the touch monitor if the first password is different from the second password.

20. The process of claim 19, wherein the controller means is configured to provide a signal to disable the display portion.
